(19) United States
(12) Patent Application Publication
(10) Pub. No.: US 2025/0319470 A1
(43) Pub. Date: Oct. 16, 2025

(54) A PACKAGING FOR HOLDING TWO RECTANGULAR SHAPED PIPETTE TIP CARRIERS

(71) Applicant: Tecan Trading AG, Männedorf (CH)

(72) Inventor: Adrian SAGER, Männedorf (CH)

(73) Assignee: Tecan Trading AG, Männedorf (CH)

(21) Appl. No.: 19/083,207

(22) Filed: Mar. 18, 2025

(30) Foreign Application Priority Data
Apr. 11, 2024 (EP) 24 169 584.0

(51) Int. Cl. B01L 9/00; B65D 5/20; B65D 5/50; B65D 85/62

(52) U.S. Cl. CPC B01L 9/543; B65D 5/2057; B65D 5/5021; B65D 85/62

(57) ABSTRACT

A packaging for two pipette tip carriers comprising a peripheral side wall with two longitudinal and transverse sides providing a rectangular box with a passage connecting openings on the top and on the bottom of the box surrounded by a top rim vertically spaced apart from a bottom rim. The top rim is configured to support one of the two pipette tip carriers and the bottom rim is configured to support the other one of the two pipette tip carriers. At least one protrusion vertically extends from the top rim and at least one protrusion vertically extends from the bottom rim wherein each protrusion is configured to pass through a complementary passage in the two pipette tip carriers for horizontally positioning the two carriers on the rectangular shaped box with respect to each other.

### CROSS REFERENCE TO RELATED APPLICATIONS

This application claims priority to European patent application Nr EP24169584.0 filed Apr. 11, 2024 entitled “A PACKAGING FOR HOLDING TWO RECTANGULAR SHAPED PIPETTE TIP CARRIERS” which is incorporated by reference herein in its entirety and for all purposes.

### TECHNICAL FIELD

The current disclosure relates to a packaging for holding two rectangular shaped pipette tip carriers holding a plurality of disposable tips for use in a pipetting apparatus.

### BACKGROUND

In analytical laboratories, small liquid volumes are typically received and discharged using pipettes. Automated liquid handling platforms are frequently used for this purpose, which enable the simultaneous receiving and/or discharging of liquid volumes with high precision and, nonetheless, high throughput rates. Such liquid handling platforms very often include pipetting robots, which are equipped with disposable or single-use pipette tips to avoid cross contaminations between samples or processing liquids. Liquid handling platforms are typically charged with such disposable or single-use pipette tips, in that carrier plates or trays equipped with pipette tips or even stacks of such carrier trays are provided. Such carrier trays typically include a matrix of arrays of pipette tips, which are arranged so that a pipetting head of a pipetting robot can receive one or more of these pipette tips. Multichannel pipetting heads can collect one or more rows of pipettes or an array of pipettes from the carrier tray by coupling each of the pipetting heads to the pipettes. The pipettes are used by the robot for aspirating and dispensing sample liquids and disposed after use leading to an increased demand of disposable pipette tips which need to be stored within the pipetting robot. The storage unit in the pipetting robot needs to be resupplied with pipette carriers loaded with pipetting tips. The pipette carriers with the tips need to be produced and packaged in a compact and robust manner for transport of the carrier plates to the locations where they are used in the pipetting robots.

EP628484B discloses a packaging unit for a pair of panels holding pipette tips, the panels have an edge flange surrounding the panel for engaging a spacer frame for holding the two panels spaced apart. The pipetting tips face each other and the ends of the tips are in an intermeshing arrangement. The pair of panels which are spaced apart are packaged in a separate cardboard container with flap lids that can close the container and cover the panels holding the pipetting tips.

U.S. Pat. No. 5,318,753A discloses a box for holding an upper and a lower panel having a plurality of openings for the pipetting tips. The upper and lower panel are spaced apart in the container with the ends of the pipetting tips facing each other. The box can be closed by two lids covering the upper and lower panels with the pipetting tips.

### SUMMARY OF THE INVENTION

There is a need for an efficient and environmentally friendly packaging for the pipette tip carriers for disposable pipetting tips requiring less material both on the pipetting carriers and on the packaging.

Furthermore, simple and stable packaging solutions are preferred fixating the pipette carriers during transportation.

It is an objective of the present disclosure to provide an alternative packaging for the pipetting carriers requiring less material and which provide a stable protective enclosure for the pipetting carriers and for the pipettes in the carriers.

Those objectives are solved by the independent claims, further exemplary embodiments are evident from the dependent claims and the following description including the Figures.

A first aspect relates to a packaging for holding two rectangular shaped pipette tip carriers holding, or configured to hold, a plurality of disposable tips for use in a pipetting apparatus. The packaging includes a peripheral side wall with two longitudinal sides and two transverse sides providing a rectangular shaped box with a passage connecting openings on the top and on the bottom of the rectangular shaped box. A rectangular shaped and horizontally oriented top rim surrounds the opening on the top which is vertically spaced apart from a rectangular shaped and horizontally oriented bottom rim that surrounds the opening on the bottom of the box. The top rim is configured to support one of the two rectangular shaped pipette tip carriers and the bottom rim is configured to support the other one of the two rectangular shaped pipette tip carriers. The engagement between the bottom rim and the top rim vertically spaces the two pipette tip carriers apart from each other. The packaging includes at least one protrusion or flap vertically extending from the top rim and at least one protrusion or flap vertically extending from the bottom rim wherein each of the at least one protrusion or flap is configured to pass through a complementary passage in each of the two pipette tip carriers for horizontally positioning the two pipette tip carriers on the rectangular shaped box with respect to each other. The engagement between the openings in the pipette tip carrier and the flap stabilize the packaging in that it prevents buckling of the peripheral side wall of the box and therewith secure the axial spacing of the two pipette tip carriers during impact or mechanical loading, for example during transport. The top rim and bottom rim are configured to support a plate or skirt of the pipette tip carrier and the complementary passage is in the plate of the carrier, preferably in a skirt section.

The protrusions or flaps may include barbed hooks for temporarily fixating the pipette tip carrier to the packing via the barbed hook passing through the complementary passage in the pipette tip carrier followed by an axial shift in the horizontal direction.

The protrusions or flaps may be integrated into the peripheral wall of the box or may be connected to the peripheral wall as separate parts. The flaps may be integrated into the box as the box is folded from a punched sheet of material.

The engagement between the at least one protrusion or flap and the complementary passage prevents movement of the pipette tip carrier in the horizontal plane along the longitudinal side or transverse side of the top rim or bottom rim while the pipette tip carrier may be moved vertically. Optionally, the pipette tip carrier has to be moved horizontally to release the carrier from a barbed hook. The engagement between the flap and the complementary passage is a releasable engagement such that the pipette tip carrier may be removed from the packaging in the vertical direction. The engagement fixates the top rim and bottom rim of the packaging to the pipette tip carrier, for example to the plate of the pipette tip carrier such that vertical loads on the pipette tip carriers are effectively transferred to the rectangular shaped box and prevent buckling of the box or pipette tip carriers getting dislodged from the top or bottom rim and falling into the box. The engagement further stabilizes the rectangular shaped box against deformation into a parallelogram.

The bottom and top rims of the packaging are vertically spaced apart and thereby axially space the two pipette tip carriers apart when the bottom and top rims engage the carriers. The space within the rectangular shaped box may be available for the pipetting tubes of the pipette tips.

In an embodiment, the at least one protrusion or flap vertically extending from the top rim and the at least one protrusion or flap vertically extending from the bottom rim are aligned with respect to another in that they are horizontally positioned at the same location on the top rim and bottom rim. A symmetric arrangement of the pipette tip carriers will be achieved when the two pipette tip carriers have the complementary passage at the same location in the skirt.

In an embodiment, the at least one protrusion or flap vertically extending from the top rim and the at least one protrusion or flap vertically extending from the bottom rim are not aligned with respect to another in that they are horizontally positioned at different locations on the top rim and bottom rim. An asymmetric arrangement of the pipette tip carriers will be achieved when the two pipette tip carriers have the complementary passage at the same location in the skirt.

The at least one protrusion or flap vertically extending from the top rim and the at least one protrusion or flap vertically extending from the bottom rim may protrude from the longitudinal sides of the peripheral side wall. Alternatively, the at least one protrusion vertically extending from the top rim and the at least one protrusion vertically extending from the bottom rim protrude from the transverse sides of the peripheral side wall.

The packaging may include two protrusions vertically extending from two opposing sides of the top rim or bottom rim of the box. The two protrusions or flaps may extend from the two transverse sides of the rectangular box, or the two protrusions may extend from the two longitudinal sides of the box. Two protrusions or flaps on the box are combined with pipette tip carriers provided with two complementary passages in the skirt for efficient load transfer from the pipette tip carrier to the packaging and for stabilizing the rectangular box.

A top cover may be attached to and vertically extend from the top rim and a bottom cover may be attached to and vertically extend from the bottom rim, the top cover and bottom cover are configured to be flexed for horizontally aligning the top cover with the top rim and horizontally aligning the bottom cover with the bottom rim for covering the two rectangular shaped pipette tip carriers. The top and bottom cover may originally extend in the vertical direction and the covers may be connected to the box by predetermined fold lines. The top and bottom covers may be integrated into the box, for example stamped from a sheet of cardboard, or the covers may be attached to the box as a separate part.

The top cover may be attached to one of the longitudinal sides or transverse sides on the top rim and the at least one protrusion or flap extending from the top rim extends from the other one of the longitudinal side or transverse side of the top rim. The bottom cover may be attached to one of the longitudinal side or transverse side on the bottom rim and wherein the at least one protrusion extending from the bottom rim extends from the other one of the longitudinal side or transverse side of the bottom rim.

The top cover and bottom cover may each include a closure lid for closing the packaging. The closure lid may extend from the top or bottom cover and may be configured to engage a complementary closure slit in the peripheral wall of the box. Closing the rectangular shaped box after carrier insertion and tilting the top cover and bottom cover followed by lid closure further mechanically stabilizes the packaging.

The packaging may be made from a sheet of cardboard or a thin sheet of plastic and is preferably made by punching or laser cutting the peripheral wall elements, the flaps or protrusions and the cover from a single sheet followed by folding and fixating the packaging into the box shape. The sheet of cardboard may be coated or laminated with another material. The another material may reinforce the cardboard. The packaging may be made from a composite material or from a foamed material. The sheet of cardboard or thin sheet of plastic or foamed plastic may be embossed or partially cut, for example to display a brand name. The brand name or technical information such as the production date, expiry date, or recycling instructions may be printed on the outside surface of the packaging. Additional folds oriented in the vertical direction may further mechanically strengthen the packaging.

A second aspect relates to an assembly including the packaging described above and two pipette tip carriers holding a plurality of disposable tips for use in a pipetting apparatus wherein each of the two pipette tip carriers includes a rectangular skirt or plate with a lower surface for engaging each the top rim or the bottom rim of the rectangular shaped box such that the lower surfaces of the two pipette tip carriers face each other.

The rectangular plate or skirt of each pipette tip carrier includes at least one opening providing the complementary passage for the at least one protrusion or flap vertically extending from the top rim or the at least one protrusion or flap vertically extending from the bottom rim.

The at least one opening is preferably a rectangular shaped opening. In an embodiment, the pipette tip carrier includes two openings positioned on opposite sides of the pipette tip carrier, for example on the two transverse sides or the two longitudinal sides of the rectangular shaped pipette tip carrier.

The pipette tip carrier includes a plurality of pipette bores or passages for nesting disposable pipette tips and wherein each disposable pipette tip includes a pipette tube connected to a collar, the collar engaging a pipette bore and wherein the pipette tubes of the pipette carrier engaging the top rim are intermeshing with the pipette tubes of the disposable pipette tips nested in the pipette carrier engaging the bottom rim. Typically, the outer diameter of the collar of the pipette exceeds the inner diameter of the passage such that the collar may abut a top surface of the carrier whereas the pipette tube has an outer diameter below the inner diameter of the passage such that the tube extends through the passage.

The top cover attached to the top rim and the bottom cover attached to the bottom rim of the packaging may covering the two rectangular shaped pipette tip carriers, for example by folding the top and bottom cover from the horizontal position to the vertical position after insertion of the two pipette tip carriers and attaching the lids to the box.

The assembly of the packaging with the two pipette tip carriers may be further enclosed in a secondary packaging. The secondary packaging may be a blister, a peel pouch, a foil, a paper packaging and the like. The secondary packaging may provide a barrier against gaseous diffusion such that the assembly may be packaged in an inert gas environment such as nitrogen. The secondary packaging may be made from a polyamide film optionally coated with a polyolefin (PP, PE) layer. The secondary packaging may prove a barrier against contamination such as biological contamination with DNA/RNA fragments or endotoxins. The assembly packaged in the secondary packaging may be sterilized using gamma, e-beam or X-ray radiation. Alternatively, the secondary packaging may include a porous membrane such as a Tyvek membrane allowing for gas sterilization using hydrogen peroxide or ethylene oxide gas.

These and other aspects of the invention will be apparent from and elucidated with reference to the embodiments described hereafter.

### BRIEF DESCRIPTION OF THE DRAWINGS

Embodiments of the present disclosure are described in more detail with reference to the attached drawings presenting:

FIG. 1: Perspective view from the top for a pipette tip carrier according to the present disclosure,

FIG. 2: Perspective view from the bottom for a pipette tip carrier according to the present disclosure,

FIG. 2a: Bottom view for a pipette tip carrier according to another embodiment,

FIG. 3: Detail of a corner section of the pipette tip carrier holding pipettes and a gripper of a pipetting robot,

FIG. 4a: Detail for a thin rectangular skirt section of the pipetting carrier allowing for pick-up of the first row of pipetting tips using the pipetting robot,

FIG. 4b: Detail for a medium thickness rectangular skirt section of the pipetting carrier allowing for pick-up for the first row of pipetting tips using the pipetting robot,

FIG. 4c: Detail for a high thickness rectangular skirt section of the pipetting carrier preventing pick-up of the first row of pipetting tips using the pipetting robot due to a collision of the collar adapter of a pipetting head with the skirt before pick-up of the pipette tips,

FIG. 4d: Detail for thin rectangular skirt section of the pipetting carrier allowing missing tip detection in the carrier,

FIG. 4e: Detail for rectangular skirt section of the pipetting carrier not allowing detection of missing tip due to a hard stop of the collar adapter on the skirt of the carrier,

FIG. 5: Packaging for the pipette tip carrier presented in FIGS. 1 and 2 in an unfolded configuration,

FIG. 6: Folded packaging for the pipette tip carrier presented in FIGS. 1 and 2,

FIG. 7: Packaging holding two pipette tip carriers,

FIG. 8: Longitudinal section of the packaging presented in FIG. 7,

FIG. 9: Perspective top view for a spacer for the pipette tip carrier presented in FIGS. 1 and 2,

FIG. 10: Perspective bottom view for a spacer for the pipette tip carrier,

FIG. 11: Exploded view of two spacers with three pipette tip carrier positioned there between,

FIG. 12: Stack of pipette tip carriers and spacers,

FIG. 13: Longitudinal section of the stack of FIG. 12,

FIG. 14: Detail for the corner section of the stack,

FIG. 15: Detail for spacer-to-spacer stacking via spacer protrusions and openings in the longitudinal skirt section of the pipette tip carrier,

FIG. 16: Detail for the corner section, cross sectional view.

### DETAILED DESCRIPTION OF EXEMPLARY EMBODIMENTS

Definitions: The distal end or distal direction is defined by the flow direction for the liquid, thus the distal tip of a pipette is defined by the outlet of the pipette tip and the proximal end is opposite to the distal end. The term subjacent means underlying or below; the term superjacent means lying above or on-top. In the claims, the word “comprising” does not exclude other elements or steps, and the indefinite article “a” or “an” does not exclude a plurality. For example, “an opening” does not exclude the fact that there may be two openings that functionally or structurally fulfill the purpose of “an opening”.

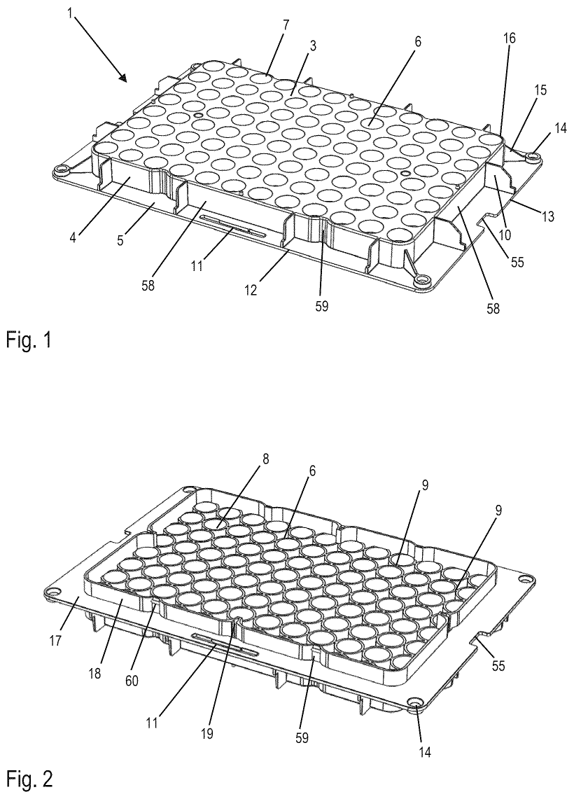

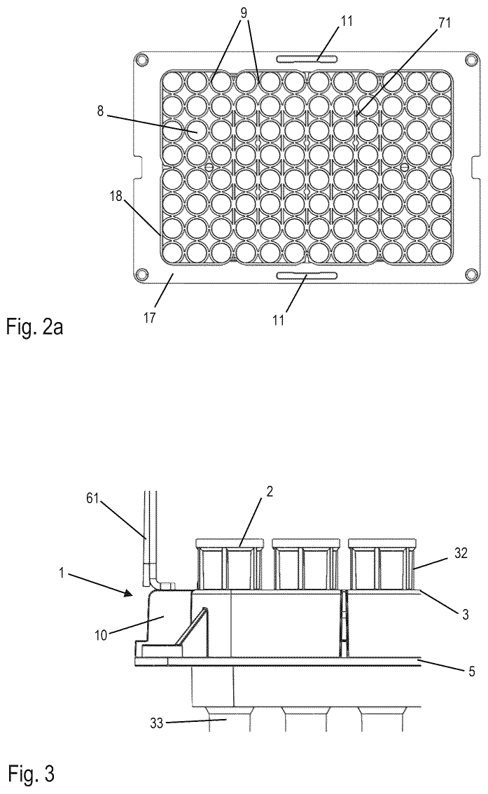

Perspective top and bottom views for a pipette tip carrier 1 according to an embodiment of the invention are presented in FIGS. 1 and 2, respectively. The pipette tip carrier 1 has a rectangular outer shape with a rectangular shaped top plate 3 surrounded by a peripheral wall 4 which connects the top plate 3 to a rectangular skirt 5. The top plate 3 defines a horizontal plane and the rectangular skirt 5 is oriented horizontal as well. The top plate 3 includes a plurality of circular openings 7 which are organized in a matrix of rows and columns according to ANSI/SLAS Microplate Standards, for example according to the 96 well-plate standard (ANSI SLAS 4-2004 (R2012): Well Positions). Hollow cylinders 6 depend from, or start at the circular openings 7 providing a matrix of passages 8 through the pipette tip carrier 1. The pipette tip carrier may releasably hold disposable pipette tips 2 using the passages 8 (see FIG. 3). The peripheral wall 4 may include a labelling section 58 for printing information such as the brand name or a two- or three-dimensional barcodes for identification or logistic purposes. The peripheral wall 4 may further include indentions 59. The rectangular skirt 5 includes a longitudinal side 12 and a transverse side 13 and is relative thin for a material saving product. The thickness of the skirt is below 3 mm, preferably below 2 mm, more preferably below 1.5 mm. The relatively thin rectangular skirt 5 is strengthened by a plurality of rim ribs 10 connecting the top surface of the rectangular skirt 5 to the peripheral wall 4. The rim ribs 10 furthermore provide guidance to and limit the horizontal play for a lid that may be placed on top of the pipette tip carrier 1. The top surface of the rim ribs 10 may be used for mechanically detecting the presence of the pipette tip carrier by a gripper of a pipetting robot. The space between two rim ribs 10 on the peripheral wall or on the top surface of the skirt 5 may provide for the labelling section 58. The rectangular skirt 5 includes openings 14 at each corner of the pipette tip carrier which are adapted to engage complementary protrusions of a spacer that will be placed below the pipette tip carrier as will be discussed further below. Alternatively, the openings 14 engage protrusions of a pipetting box that is fixated on the working table of the pipetting robot. A circular rim may surround each opening 14 providing an entrance section, for example a facetted rim, for guiding the protrusions during stacking of the spacers and the pipette tip carriers. The circular rim may further locally strengthen the rectangular skirt 5 in the corner section. The openings 14 may be dimensioned that there is horizontal play between the opening 14 and the protrusion of the spacer or there may be a friction fit engagement between the outer surface of the protrusion and the inner surface of the opening 14. The form-fit engagement may enable the temporary transport of an assembly of a spacer and a carrier via gripping the carrier only. Preferably, only the spacer is gripped by the pipetting robot, either ina form fit or friction fit engagement.

A corner rib 15 may connect the opening 14 or the circular rim surrounding the opening 14 to the peripheral wall 4, preferably to the corner 16 of the peripheral wall. The rectangular skirt 5 may further include at least one opening 11, preferably two openings 11 penetrating the two longitudinal sides 12 or the two transverse side 13 of the skirt. The opening 11 may have a rectangular, circular or triangular shape and provide a passage for a complementary protrusion of a superjacent spacer. The corners of the opening may be rounded and the edges of the opening may include a facet. The opening 11 may be surrounded by a rim for mechanically supporting the rectangular skirt 5 surrounding the opening 11. The rectangular skirt 5 may include a cut out 55 providing a passage for a protrusion of a superjacent spacer.

The pipette tip carrier 1 may include a bottom wall 18 vertically extending from the bottom surface 17 of the rectangular skirt 5. The bottom wall 18 surrounds the matrix of the passages 8 and the ends of the cylinders 6 providing the passages 8 are preferably even or flush with the bottom surface 17 of the rectangular skirt 5. Alternatively, the cylinders penetrate beyond the bottom surface 17 although further extension of the cylinders beyond the bottom surface 17 may lead to unnecessary use of material. The further extension of the cylinders may mechanically reinforce the pipette tip carrier. The cylinders 6 may be directly connected to neighboring cylinders by connecting ribs 9 to mechanically strengthen the pipette tip carrier. The cylinders 6 may also intersect to neighboring cylinders without using the connecting ribs 9 and the cylinders 6 may be connected to an inner surface of the peripheral wall 4 by connecting ribs or, as presented in FIG. 2, the cylinders may intersect with the inner surface of the peripheral wall 4. The thickness of the ribs may vary depending on the position within the pipette tip carrier according to the local needs defined by the mechanical stresses in the carrier upon vertical loading. The ribs 9 may be thicker in the center of the carrier compared to the ribs in the outer regions towards the skirt 5.

The indentions 59 on the bottom wall 18 of the carrier may include horizontal ridges 60 that may act as a vertical place holder for stacking multiple carriers or may provide a snap-fit connector between two carriers or between a carrier and a patent box. The guiding member 19 on the bottom wall 18 may be used for self-alignment purposes or gripping purposed. The indentions 59 and/or the guiding members 19 may locally strengthen the bottom wall 18.

An alternative embodiment for the pipette tip carrier is presented in FIG. 2a. The view on the bottom surface 17 presents the two openings 11 in the skirt of the carrier and the bottom wall 18 penetrating from the bottom surface 17. The plurality of passages 8 for the pipette tips are surrounded by the cylinders which are connected to another by connecting ribs 9. The embodiment presented in FIG. 2a is additionally mechanically supported by reinforcement ribs 71 connecting two connecting ribs 9 to another providing vertically oriented reinforcement ribs. The reinforcement ribs 71 are vertically oriented in FIG. 2a and oriented parallel to the transverse side of the pipette tip carrier. Alternatively, the reinforcement ribs are horizontally oriented parallel to the longitudinal side of the pipette tip carrier. In yet another embodiment there are both horizontally and vertically oriented reinforcement ribs 71.

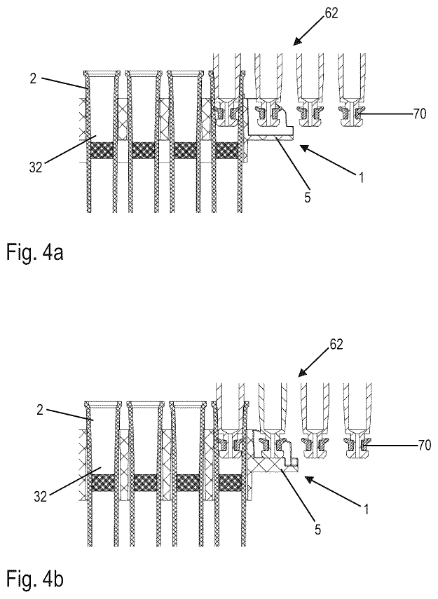

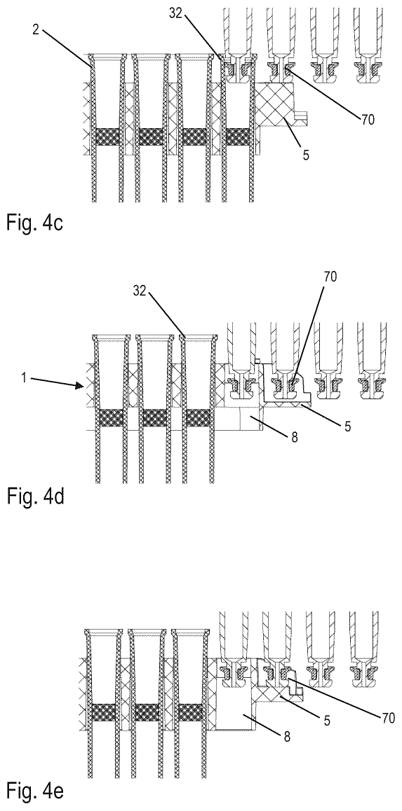

A detail of a corner section of the pipette tip carrier 1 holding pipettes 2 is presented in FIG. 3. The pipettes 2 include a collar 32 engaging the top plate 3 of the carrier and pipette tubes 33 extending from the collar 32 through the passages. A gripper 61 of a pipetting robot abuts the top surface of a rim rib 10, for example to mechanically detect if a tray is present or not. The pipetting robot may include a pipetting head 62 for collecting the pipetting tips 2, see FIGS. 4a to 4e. The thickness and position of the rectangular skirt 5 defines the height of the peripheral wall 4 this may affect the accessibility for the pick-up of single rows from the matrix of pipetting tips in the carrier (see FIGS. 4a to 4c) or the detection of a missing row of pipette tips (see FIGS. 4d and 4e). The pipetting head 62 includes multiple collar adapters 70 which are lowered towards the collars 32 of the pipettes 2 by the pipetting robot for pick-up of the pipettes. The approach is halted when the collar adapters 70 of the pipetting head abut a mechanical stop such as the rectangular skirt 5 of the carrier 1 and a thin rectangular skirt 5 (FIGS. 4a and 4b) may provide sufficient access to the pipettes in the carrier for pick-up of a single row of pipettes while the adjacent collar adapters 70 do not contact the skirt 5 surrounding the carrier. If a hard stop is detected by the pipetting robot before effective pick-up of the pipettes from the carrier, then the pick-up of the tips may be jeopardized or the pick-up of the rows may damage the hardware of the pipetting robot, see FIG. 4c where thickness of the skirt 5 affects that the collar adapter 70 abuts the skirt 5 before the adjacent collar adapter 70 can catch the pipette tip 2 from the first row. The thickness of the rectangular skirt 5 may also affect the detection of a missing row of pipettes in the pipette tip carrier. FIG. 4d presents a pipette tip carrier 1 with a missing first row of pipettes 2 and the firmware of the pipetting robot can detect the missing row as the vertical position of the pipetting head 62 with the collar adapters 70 would normally detect an increase in vertical force required for the pick-up of the pipettes as the collar adapters 70 may need to elastically deform the rim of the pipette collar 32. The collar adapter that is adjacent to the collar adapter entering the passage 8 of the pipette carrier 1 does not abut the thin-walled rectangular skirt 5. A circumferential skirt 5 with a higher thickness as presented in FIG. 4e would result in a hard stop of the collar adapter 70 adjacent to the collar adapter entering the first row of passages 8 and the hard stop on the skirt would be detected before the firmware of the pipetting robot can detect the missing row. A thin-walled circumferential skirt 5 may therefore provide a versatile solution when used in a pipetting robot.

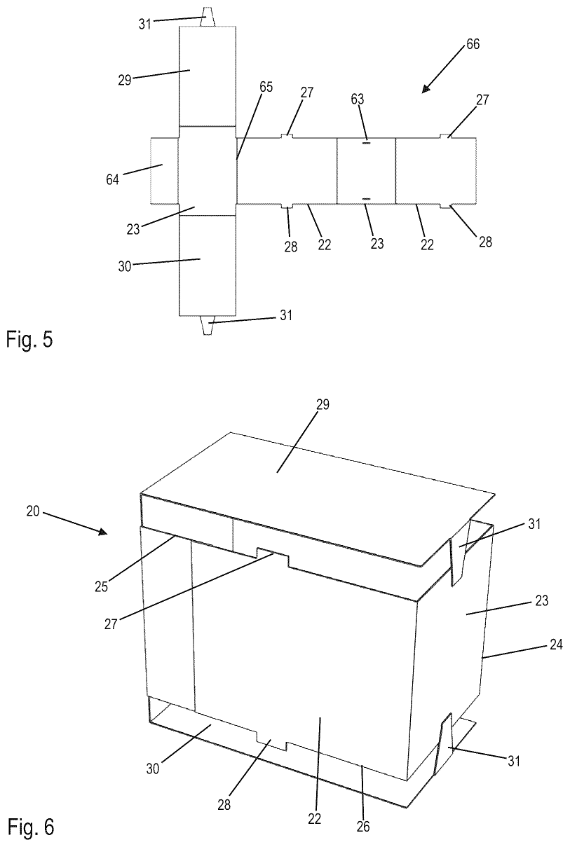

An example for a packaging 20 for the pipette tip carriers is presented in FIGS. 5 to 8. The packaging 20 is based on a foldable sheet 66 that is punched from a plate of a material such as cardboard, coated cardboard, plastic or a composite material. The foldable sheet 66 includes two longitudinal sides 22 connected by a transverse side 23. The longitudinal sides 22 each include two protrusions or flaps, a flap or protrusion 27 and a flap or protrusion 28 which, after the sheet 66 has been folded into a rectangular shaped box 24, extend from a top rim 25 and a bottom rim 26 of the packaging 20 (see FIG. 6). A top cover 29 and a bottom cover 30 is attached to one of the two transverse sides 23 and closure lids or closure flaps extend from the top cover and bottom cover respectively. Closure slits 63 are included in the other one of the two transverse sides 23 configured for engaging the closure lids 31. A closure flap 64 is attached to one of the transverse sides 23 for closing the rectangular box 24. Fold lines or predetermined folds are integrated in the foldable sheet 66, for example perforation lines or cutting lines 65 may be integrated in the foldable sheet 66. The two protrusions or flaps 27 or 28 may include barbed hooks for releasably fixating the pipette tip carrier to the packaging.

The sheet 66 may be folded in a rectangular shaped box 24 as presented in FIG. 6 providing the folded packaging 20. A top rim 25 and bottom rim 26 extend from the upper surface and lower surface of the longitudinal sides 22 and transverse sides 23 thereby providing a top opening and bottom opening that is accessible for insertion of two pipette tip carriers 1. The top and bottom openings are surrounded by the top rim and bottom rim, respectively. The protrusions or flaps 27, 28 extend from the top rim 25 and bottom rim 26, respectively. The top cover 29 and bottom cover 30 can be bent from a vertical orientation allowing access for the carriers towards the top and bottom rim for closing the packaging.

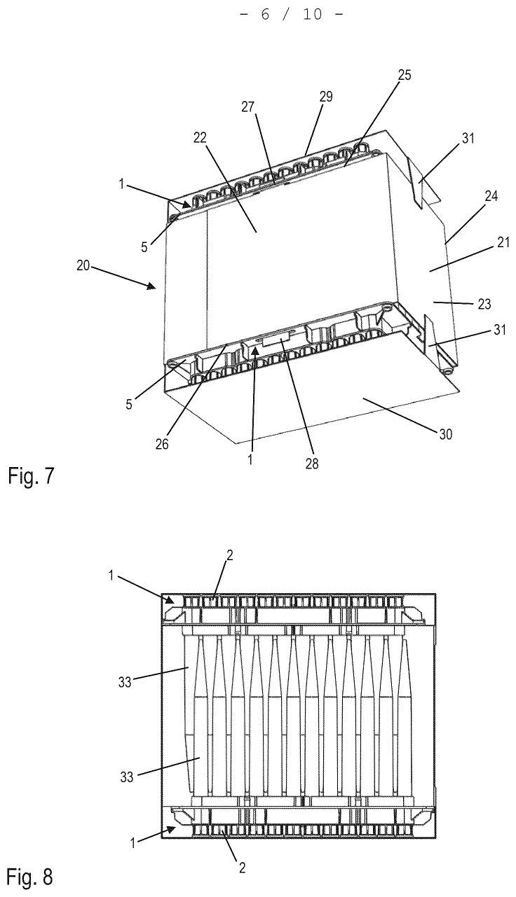

An assembly including the packaging 20 and two pipette tip carriers 1 is shown in FIG. 7. The two carriers 1 are each inserted with their respective bottom surfaces 17 of the skirt 5 facing towards the top rim 25 and bottom rim 26 of the packaging 20. The pipette tubes 33 that are releasably connected to the two pipette tip carriers are enclosed within the rectangular box 24 and the two flaps 27 extending from the top rim 25 engage the openings 11 of one of the two pipette tip carriers. The two flaps 28 extending from the bottom rim 26 engage the two openings 11 of the other one of the two pipette tip carriers. The optional barbed hooks on the flaps may provide a temporary fixation of the carrier to the packaging. The bottom surface 17 on the rectangular skirt 5 of each pipette tip carrier is supported by the top and bottom rim 25, 26 of the rectangular box 24 and the engagement between the protrusions 27, 28 and the openings 11 may prevent dislodgement between the rectangular skirt 5 of the carriers and the rectangular box 24. The packaging 20 is closed by folding the top cover 29 and bottom cover 30 such that the covers are aligned with the horizontal plane of the pipette tip carriers. The closure lids 31 are attached to transverse side 23 of the packaging using slits 63 (see FIG. 5). A longitudinal section through the packaging filled with two pipette tip carriers holding pipette tips is shown in FIG. 8. The pipette tubes 33 of each carrier are intermeshing for a space saving arrangement of the pipette tips 2. The two pipette tip carriers 1 may be removed from each side of the box after opening the closure lids 31 and tilting the top cover 29 and bottom cover 30 towards a vertical position.

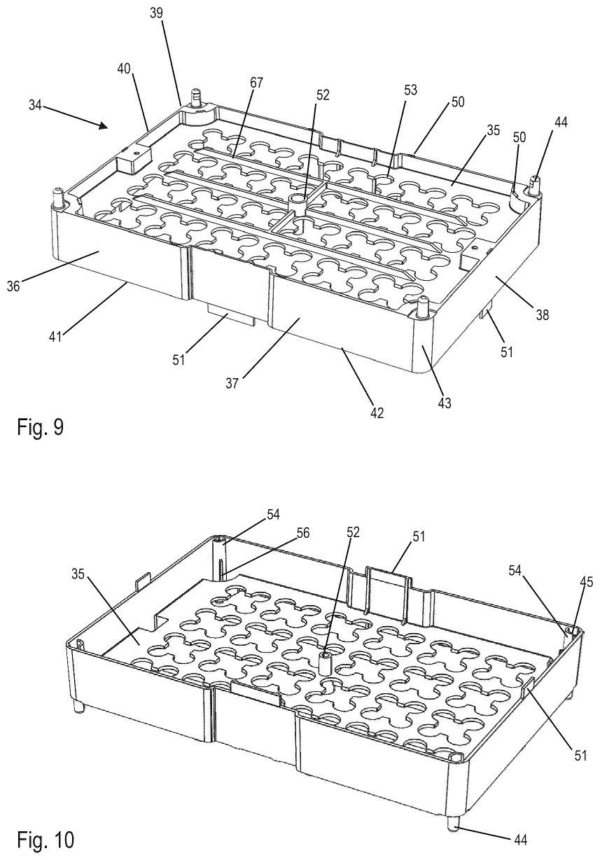

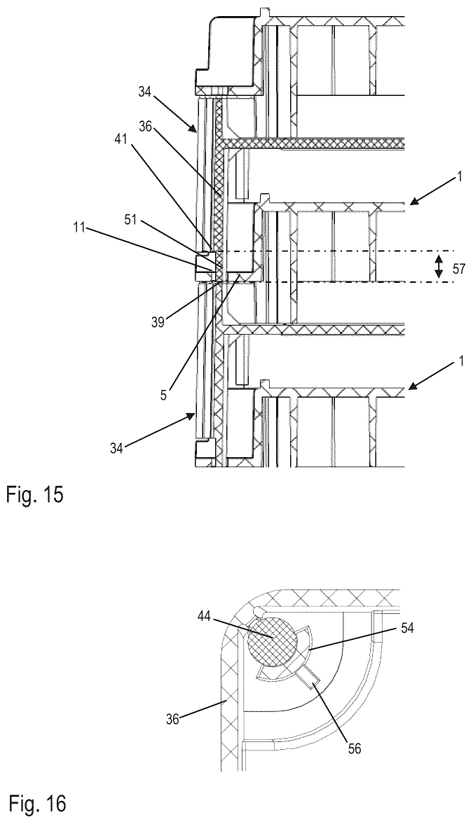

A rectangular shaped spacer 34 for stacking pipette tip carriers is presented in FIGS. 9 and 10. The spacer 34 includes a horizontal base surface 35 surrounded by a peripheral side wall 36 oriented essentially vertical with respect to the base surface 35. The base surface 35 includes semi-circular openings 53 with centers oriented to the same pattern as passages 8 in the pipette tip carrier. The semi-circular openings may intersect leading to a plurality of shamrock-shaped openings. The openings provide a passage for the pipetting tubes 33 of pipetting tips 2 engaging a pipette tip carrier positioned on top of the spacer 34 and prevent dislodgement of the collars 33 from a pipette tip carrier positioned below the spacer 34. The horizontal base surface 35 is strengthened with corrugated structures 67 such that material is added to the base surface where mechanically needed. The peripheral side wall 36 includes two longitudinal sides 37 and two transverse sides 38 providing an upper rim 40 and lower rim 42 which are oriented parallel to another. Ledges 50 project upwards from an upper surface 39 of the upper rim and protrusions 51 project downwards from a lower surface 41 of the lower rim 42. Protrusions 44 protrude upwards from the upper surface 39 in each corner of the rectangular shaped spacer 34. A projection 52 protrudes from the center of the rectangular shaped spacer 34 towards the upper rim 40 (FIG. 9) and protrudes from the center towards the lower rim 42 as well (FIG. 10). Load transfer elements 43 are located on each corner of the rectangular shaped spacer 34 which include the protrusion 44 and stop surfaces 45. Optionally, there are additional load transfer elements located between the corners of the spacer. Further details for the load transfer elements will be explained in FIGS. 14 and 15. The perspective bottom view in FIG. 10 further presents spring elements 54 that surround the stop surfaces 45 in each corner and the spring elements 54 are connected to the bottom surface of the horizontal base surface 35 and the free end of the spring element 54 may flex towards the center or towards the corner of the rectangular shaped spacer 34. The spring element 54 may be mechanically supported by a support rib 56 that protrudes from the bottom surface of the base 35. The load transfer elements 43 provide for the transfer of a vertical load from a spacer to a subjacent spacer whereas the spring elements 54 provide for a correct spacer-to-spacer alignment in a stack of spacers.

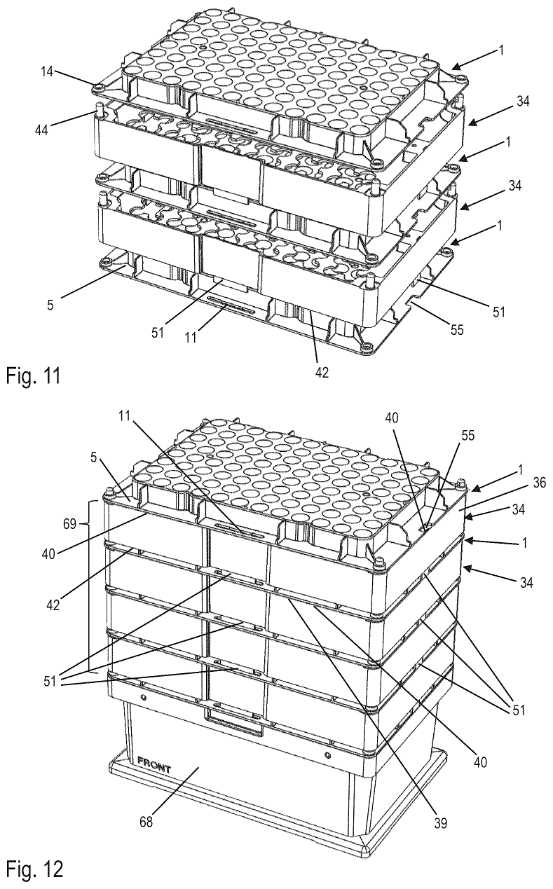

An exploded view of a stack of alternating spacers 34 and pipette tip carriers 1 is depicted in FIG. 11. Each pipette tip carrier 1 is positioned with the openings 14 on each corner onto the protrusions 44 on each corner of a subjacent spacer. The protrusions 51 protruding from the lower rim 42 of each spacer 34 are aligned with the cut outs 55 and the openings 11 in the rectangular skirt 5 of each pipette tip carrier 1 such that the openings 11 provide a passage for the protrusions, preferably without contacting or abutting the protrusions 51 thereby avoiding vertical load transfer from a spacer 34 to a pipette tip carrier 1 positioned below the spacer. The play in the horizontal plane between the protrusions 51 on the spacers and the cut outs 55 or the openings 11 on the carriers is sufficient to avoid direct contact.

The stacked pile 69 of spacers 34 and carriers 1 is shown in FIG. 12. The stack is placed on top of a pipette box 68 releasably holding the stack such that the stack or part of the stack may be removed by a gripper of a pipetting robot. The pipette box 68 may be fixated on a working table of the pipetting robot. Each pipette tip carrier 1 is placed on the upper surface 39 of the upper rim 40 of a subjacent spacer. Optionally, the carrier is supported by the ledges 50. The protrusions 51 protruding downwards from the lower rim of each spacer abut the upper surface 39 of a subjacent spacer either via the cut-outs 55 or via the openings 11 in the rectangular skirt 5 of each pipette tip carrier 1. The pipette tip carriers 1 are within a vertical space or gap between two spacers 34 and the vertical load applied to the pipette tip carrier 1 on top of the pile is transferred via the rectangular skirt 5 to the upper rim 40 of the first spacer 34 and the vertical load is subsequently transferred to the second spacer 34 via the load transfer elements 43 on each corner of the first spacer and/or via the protrusions 51 extending from the lower rim of the first spacer. The vertical load is finally transmitted to the worktable of the pipetting robot via the pipetting box 68. Details for the load transfer via the load transfer elements 43 are presented in FIG. 14 and details for the load transfer via the protrusions 51 are presented in FIG. 15.

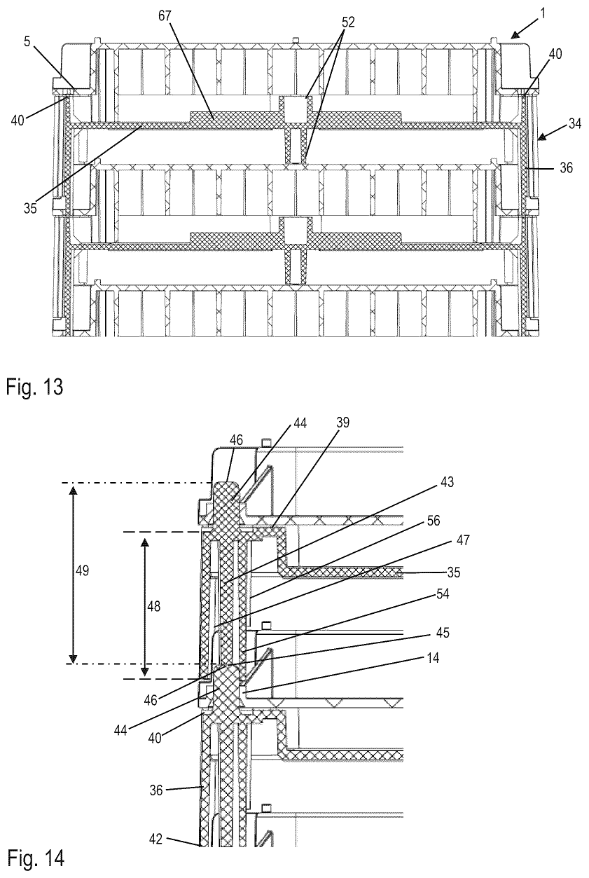

A longitudinal section for the stack is depicted in FIG. 13. The vertical load from the pipette tip carrier 1 on the top is transmitted via the rectangular skirt 5 to the upper rim 40 of the first spacer 34. The first spacer 34 includes the base surface 35 surrounded by the peripheral side wall 36 and the base surface 35 is strengthened by the corrugated structures 67 (see also FIG. 9). In case the pipette carrier 34 on top flexes or bends due to the vertical load, then the projections 52, which do not contact the subjacent or superjacent pipette tip carriers in a resting position, may additionally absorb the vertical loads thereby transferring a minor part of the load in the center from the pipette tip carrier on the top to the first spacer and, eventually, from the first spacer to the next pipette tip carrier.

Details for the load transfer elements are presented in FIG. 14. Starting from the bottom of the illustration: The spacer below the pipette tip carrier provides the protrusion 44 passing through the corner opening 14 of the pipette tip carrier 1 and the top surface 46 of the protrusion 44 abuts the stop surface 45 of the spacer positioned above the pipette tip carrier 1. There is a gap 57 (see FIG. 15) between the two spacers that is available for the pipette tip carrier preventing load transfer to the carrier. The vertical height of the peripheral wall 36 is defined by the distance 48 between the upper rim 40 and the lower rim 42 whereas the height of the load transfer element 43 is defined by the vertical distance 49 between the end of the protrusion 46 and the stop surface 45. The vertical distance 49 exceeds the height 48 of the peripheral wall 36 thereby leaving the gap below the lower rim 42 of each spacer that is available for the pipette tip carrier. Each pipette tip carrier may be placed on the upper rim 40 of a first spacer 34 and a second spacer may be placed on top of the first spacer, and the lower rim 42 of the second spacer will not contact the rectangular skirt 5 surrounding the pipette tip carrier.

Further details for the protrusions 51 of a spacer engaging the top surface of a subjacent spacer are shown in FIG. 15. The protrusions 51 projecting downwards from the longitudinal side of the lower surface 41 of a superjacent spacer 34 abut the upper surface 39 of a subjacent spacer 34 via the opening 11 in the pipette tip carrier 1. The abutment of the protrusions 51 projecting downwards from the transverse sides provide a comparable sectional view with the only difference in that the opening 11 is replaced by the cut-out 55.

The vertical loads applied to a pipette tip carrier may thus be transferred in a stack of spacers and carriers via the load transfer elements 43 on each corner, and/or via the protrusions 51 on the longitudinal sides of the spacer, and/or via the protrusions 51 on the transverse sides of the spacer for a direct spacer-to-spacer load transfer. Optionally a part of the vertical load is transmitted via the central projections 52 for spacer-to-carrier loading.

The spacer 34 includes spring elements 54 on each corner as presented in FIGS. 10, FIG. 15 and FIG. 16. When placing a spacer 34 onto another spacer carrying a pipette tip carrier, then the placement may be accompanied by a shift in the horizontal plane of the one spacer versus the another spacer. The play in the horizontal plane is compensated for or eliminated using the spring elements 54 located on each corner. The spring element 54 protrudes from the bottom surface of the horizontal base 35 towards the lower rim 42 and can flex along the diagonal of the rectangular shaped spacer towards the center or towards the corner of the peripheral wall 36. The spring element 54 of a spacer may have a semi-circular shape for at least partially surrounding the protrusion 44 protruding upwards from of a subjacent spacer. The spring elements of the top spacer on each corner can flex when engaging the protrusions 44 of a subjacent spacer and thereby self-center the spacer with respect to the subjacent spacer and compensate for horizontal misplacement or provide a barrier against twisting the stack of spacers. The twist barrier provides a resilient realignment force when torquing the top of the stack with respect to the bottom of the stack. Reliable pick-up of the pipettes from the carriers depends on the accuracy for the movements of the pipetting robot and on the dimensional tolerances for a stack of the spacers and the pipette tip carriers. The self-centering spring elements may thus reduce the stack-up of tolerances induced by the placements and handling of the spacers and carrier. The flexibility or resilience of the spring element may be tuned by the material used for the spring element 54 and/or the wall thickness of the spring elements and/or the use of a support rib 56 protruding along the back surface of the spring element 54 towards the end of the spring element. The spring element 54 may surround the stop surface 45 on each corner thereby acting as a guiding element guiding the post 44 of a subjacent spacer towards the stop surface of the spacer on top during spacer placement, see FIG. 16.

FIG. 15 furthermore presents the gap 57 between the two spacers 34 that is available for the pipette tip carrier 1 placed between the two spacers. The height of the gap 57 is defined by the difference between the length of the transfer element 49 and the vertical distance 48 between the upper and lower rim of the spacer as presented in FIG. 14. FIG. 14 furthermore presents the spring elements 54 in the longitudinal sectional view engaging the protrusion 44 of a subjacent spacer. The spring elements 54 for guiding and aligning the spacers act during pile-up or stacking of the spacers and pipette tip carriers onto each other, this operational step in the laboratory automation procedure is done before starting the liquid handling procedure with the pick-up, and therewith vertical loading of the stacks. The spacer presented above in combination with the trays therefore allows for a separation of the correct alignment during stacking and an effective transfer of the vertical loads during liquid handling and this in combination with spacers and pipette tip carriers that require less material during manufacturing and have a lower carbon footprint.

The mere fact that certain elements or steps are recited in distinct claims shall not preclude the existence of further meaningful combinations of these elements or steps.

LIST OF REFERENCE SIGNS

| | |
|---|---|
| 1 | Rectangular shaped pipette tip carrier |
| 2 | Disposable pipetting tip |
| 3 | Rectangular shaped top plate |
| 4 | Peripheral wall |
| 5 | Rectangular skirt |
| 6 | Hollow cylinder |
| 7 | Circular opening |
| 8 | Passage |
| 9 | Ribs, connecting ribs |
| 10 | Skirt ribs |
| 11 | Opening |
| 12 | Longitudinal side |
| 13 | Transverse side |
| 14 | Opening, corner opening |
| 15 | Corner rib |
| 16 | Corner peripheral wall |
| 17 | Bottom surface |
| 18 | Bottom wall |
| 19 | Guiding member |
| 20 | Packaging |
| 21 | Peripheral side wall |
| 22 | Longitudinal side |
| 23 | Transverse side |
| 24 | Rectangular shaped box |
| 25 | Top rim |
| 26 | Bottom rim |
| 27 | Protrusion, flap extending from top rim |
| 28 | Protrusion, flap extending from bottom rim |
| 29 | Top cover |
| 30 | Bottom Cover |
| 31 | Closure lid |
| 32 | Pipette collar |
| 33 | Pipette tube |
| 34 | Rectangular spacer |
| 35 | Horizontal base surface |
| 36 | Peripheral side wall |
| 37 | Longitudinal side |
| 38 | Transverse side |
| 39 | Upper surface |
| 40 | Upper rim |
| 41 | Lower surface |
| 42 | Lower rim |
| 43 | Load transfer element |
| 44 | Protrusion |
| 45 | Stop surface |
| 46 | End of protrusion |
| 47 | Rib |
| 48 | Vertical distance upper-lower rim |
| 49 | Length load transfer element |
| 50 | Ledge |
| 51 | Protrusion |
| 52 | Projection |
| 53 | Opening |
| 54 | Spring element |
| 55 | Cut-out |
| 56 | Support rib |
| 57 | Gap |
| 58 | Labelling section |
| 59 | Indentions |
| 60 | Ridge |
| 61 | Gripper pipetting robot |
| 62 | Pipetting head |
| 63 | Slits |
| 64 | Closure flap |
| 65 | Predetermined folding line; predetermined fold |
| 66 | Foldable sheet |
| 67 | Corrugated structure |
| 68 | Pipette box |
| 69 | Stacked pile |
| 70 | Collar adapter |
| 71 | Reinforcement rib |

1. A packaging for holding two rectangular shaped pipette tip carriers holding a plurality of disposable tips for use in a pipetting apparatus, the packaging comprises:
a peripheral side wall with two longitudinal sides and two transverse sides providing a rectangular shaped box with a passage connecting openings on the top and on the bottom of the rectangular shaped box,
a rectangular shaped and horizontally oriented top rim surrounding the opening on the top vertically spaced apart from a rectangular shaped and horizontally oriented bottom rim surrounding the opening on the bottom of the rectangular shaped box,
wherein the top rim is configured to support one of the two rectangular shaped pipette tip carriers and the bottom rim is configured to support the other one of the two rectangular shaped pipette tip carriers,
wherein at least one protrusion vertically extending from the top rim and at least one protrusion vertically extending from the bottom rim wherein each of the at least one protrusion is configured to pass through a complementary passage in each of the two pipette tip carriers for horizontally positioning the two pipette tip carriers on the rectangular shaped box with respect to each other.

2. The packaging according to claim 1, wherein the at least one protrusion vertically extending from the top rim and the at least one protrusion vertically extending from the bottom rim are aligned with respect to another in that they are horizontally positioned at the same location on the top rim and bottom rim.

3. The packaging according to claim 1, wherein the at least one protrusion vertically extending from the top rim and the at least one protrusion vertically extending from the bottom rim are not aligned with respect to another in that they are horizontally positioned at different locations on the top rim and bottom rim.

4. The packaging according to claim 1, wherein the at least one protrusion vertically extending from the top rim and the at least one protrusion vertically extending from the bottom rim protrude from the longitudinal sides of the peripheral side wall.

5. The packaging according to claim 1, wherein the wherein the at least one protrusion vertically extending from the top rim and the at least one protrusion vertically extending from the bottom rim protrude from the transverse sides of the peripheral side wall.

6. The packaging according to claim 4, wherein two protrusions vertically extend from two opposing sides of the top rim or bottom rim.

7. The packaging according to claim 6, wherein a top cover is attached to and vertically extends from the top rim and wherein a bottom cover is attached to and vertically extends from the bottom rim, the top cover and bottom cover are configured to be flexed for horizontally aligning the top cover with the top rim and horizontally aligning the bottom cover with the bottom rim for covering the two rectangular shaped pipette tip carriers.

8. The packaging according to claim 7, wherein the top cover is attached to one of the longitudinal sides or transverse sides on the top rim and wherein the at least one protrusion extending from the top rim extends from the other one of the longitudinal sides or transverse sides of the top rim and wherein the bottom cover is attached to one of the longitudinal sides or transverse sides on the bottom rim and wherein the at least one protrusion extending from the bottom rim extends from the other one of the longitudinal sides or transverse sides of the bottom rim.

9. The packaging according to claim 8, wherein the top cover and bottom cover each comprise a closure lid for closing the packaging.

10. The packaging according to claim 9, wherein the packaging is made from cardboard or a plastic sheet material.

11. A packaging for holding two rectangular shaped pipette tip carriers holding a plurality of disposable tips for use in a pipetting apparatus, the packaging comprises:
a peripheral side wall with two longitudinal sides and two transverse sides providing a rectangular shaped box with a passage connecting openings on the top and on the bottom of the rectangular shaped box,
a rectangular shaped and horizontally oriented top rim surrounding the opening on the top vertically spaced apart from a rectangular shaped and horizontally oriented bottom rim surrounding the opening on the bottom of the rectangular shaped box,
wherein the top rim is configured to support one of the two rectangular shaped pipette tip carriers and the bottom rim is configured to support the other one of the two rectangular shaped pipette tip carriers,
wherein at least one protrusion vertically extending from the top rim and at least one protrusion vertically extending from the bottom rim wherein each of the at least one protrusion is configured to pass through a complementary passage in each of the two pipette tip carriers for horizontally positioning the two pipette tip carriers on the rectangular shaped box with respect to each other, wherein the at least one protrusion vertically extending from the top rim and the at least one protrusion vertically extending from the bottom rim protrude from two opposing transverse sides of the peripheral side wall.

12. The packaging according to claim 11, wherein a top cover is attached to and vertically extends from the top rim and wherein a bottom cover is attached to and vertically extends from the bottom rim, the top cover and bottom cover are configured to be flexed for horizontally aligning the top cover with the top rim and horizontally aligning the bottom cover with the bottom rim for covering the two rectangular shaped pipette tip carriers.

13. The packaging according to claim 12, wherein the top cover and bottom cover each comprise a closure lid for closing the packaging.

14. The packaging according to claim 13, wherein the packaging is made from cardboard or a plastic sheet material.

15. An assembly comprising the packaging according to claim 4 and two pipette tip carriers holding a plurality of disposable tips for use in a pipetting apparatus wherein each of the two pipette tip carriers comprises a rectangular skirt with a lower surface for engaging each the top rim or bottom rim of the rectangular shaped box such that the lower surfaces of the two pipette tip carriers face each other.

16. The assembly according to claim 15, wherein the rectangular skirt of each pipette tip carrier comprises at least one opening providing a complementary passage for the at least one protrusion vertically extending from the top rim or the at least one protrusion vertically extending from the bottom rim.

17. The assembly according to claim 16, wherein the at least one opening is a rectangular opening.

18. The assembly according to claim 15, wherein the pipette tip carrier comprises a plurality of pipette bores for nesting disposable pipette tips and wherein each disposable pipette tip comprises a pipette tube connected to a collar, the collar engaging one of the plurality of pipette bores and wherein the pipette tubes of the pipette carrier engaging the top rim are intermeshing with the pipette tubes of the disposable pipette tips nested in the pipette carrier engaging the bottom rim.

19. The assembly according to claim 18, wherein the packaging comprises a top cover attached to the top rim and a bottom cover attached to the bottom rim wherein the top cover and bottom cover are covering the two rectangular shaped pipette tip carriers.
